(19) United States
(12) Patent Application Publication
(10) Pub. No.: US 2023/0288902 A1
(43) Pub. Date: Sep. 14, 2023

(54) BALANCE CORRECTION ASSISTANCE DEVICE, MACHINE TOOL, AND BALANCE CORRECTION ASSISTANCE METHOD

(71) Applicant: FANUC CORPORATION, Yamanashi (JP)

(72) Inventor: Masahiro MUROTA, Yamanashi-ken (JP)

(21) Appl. No.: 18/013,986

(22) PCT Filed: Jul. 8, 2021
(86) PCT No.: PCT/JP2021/025790

§ 371 Date: Dec. 30, 2022

(30) Foreign Application Priority Data
Jul. 10, 2020 (JP) 2020-119143

(51) Int. Cl. G05B 19/404; B23Q 23/00

(52) U.S. Cl. CPC G05B 19/404; B23Q 23/00; G05B 2219/36421

(57) ABSTRACT

A balance correction assistance device includes a storage unit that stores an attachment/detachment position, where a weight for adjusting the balance of the rotating body is attached and detached, and a predetermined operation position, where the weight for adjusting balance is attached to or detached from the rotating body: a rotation position information acquisition unit that acquires, from a rotation position detection unit, information indicating the rotation position of the rotating body: a determination unit that determines, on the basis of the rotation position, a rotation angle difference, between the operation position and current attachment/detachment position, in the circumferential direction of the rotating body: and a notification control unit that, if the absolute value of the rotation angle difference is less than a first threshold, issues, from a notification unit an audible notification indicating that the absolute value of the rotation angle difference is less than the first threshold.

### TECHNICAL FIELD

The present invention relates to a balance correction assistance device, a machine tool, and a balance correction assistance method.

### BACKGROUND ART

JP H10-238594 A discloses a balance adjusting device for a rotating body, the device including a plurality of screw holes provided radially from a rotation center position of the rotating body and a set screw for balance adjustment, the set screw being screw-engaged into the screw hole. The balance state of the rotating body can be adjusted by attaching and detaching the set screw (weight) to and from any of the plurality of screw holes.

### SUMMARY OF THE INVENTION

However, since a plurality of screw holes are provided and the rotating body rotates, it is difficult to grasp which screw hole the weight should be attached to or detached from when attaching or detaching the weight. Thus, the balance correction task is complicated and cumbersome.

An object of the present invention is to provide a balance correction assistance device, a machine tool, and a balance correction assistance method that can contribute to facilitation of balance correction.

According to an aspect of the present invention, there is provided a balance correction assistance device for assisting correction of a balance state of a rotating body having a circular shape, the balance correction assistance device including: a storage unit configured to store an attachment/detachment position that is a position on the rotating body and that is designated as a position at which a balance adjustment weight should be attached to and detached from the rotating body, and an operation position predetermined as a position at which a person or a robot performs attaching and detaching of the balance adjustment weight to and from the rotating body; a rotational position information acquisition unit configured to acquire information indicating a rotational position of the rotating body from a rotational position detector; a determination unit configured to determine a rotation angle difference in a circumferential direction of the rotating body between the operation position and the attachment/detachment position at present, based on the rotational position; and a notification control unit configured to, when an absolute value of the rotation angle difference is less than a first threshold value, cause a notification unit to notify by sound that the absolute value of the rotation angle difference is less than the first threshold value.

According to another aspect of the present invention, there is provided a machine tool includes the balance correction assistance device as described above.

According to still another aspect of the present invention, there is provided a balance correction assistance method for assisting correction of a balance state of a rotating body having a circular shape, the balance correction assistance method including: an attachment/detachment position information acquisition step of acquiring information indicating an attachment/detachment position that is a position on the rotating body and that is designated as a position at which a balance adjustment weight should be attached to and detached from the rotating body; a rotational position information acquisition step of acquiring information indicating a rotational position of the rotating body; a determination step of determining, based on the rotational position, a rotation angle difference in a circumferential direction of the rotating body between an operation position predetermined as a position at which a person or a robot performs attaching and detaching of the balance adjustment weight to and from the rotating body and the attachment/detachment position at present; and a notification step of, when an absolute value of the rotation angle difference is less than a first threshold value, notifying by sound that the absolute value of the rotation angle difference is less than the first threshold value.

According to the present invention, it is possible to provide a balance correction assistance device, a machine tool, and a balance correction assistance method that can contribute to facilitation of balance correction.

### BRIEF DESCRIPTION OF DRAWINGS

FIG. 1 is a schematic diagram showing a machine tool according to an embodiment of the present invention;

FIG. 2 is a perspective view showing part of the machine tool according to the embodiment;

FIG. 3 is a block diagram showing part of the machine tool according to the embodiment;

FIG. 4 is a schematic view showing a rotating body;

FIG. 5A is a diagram illustrating an example of a display screen;

FIG. 5B is a diagram illustrating an example of the display screen;

FIG. 5C is a diagram illustrating an example of the display screen; and

FIG. 6 is a flowchart showing the operation of a balance correction assistance device according to an embodiment of the present invention.

### DETAILED DESCRIPTION OF THE INVENTION

A preferred embodiment of a balance correction assistance device, a machine tool, and a balance correction assistance method according to the present invention will be described in detail below with reference to the accompanying drawings.

### Embodiment

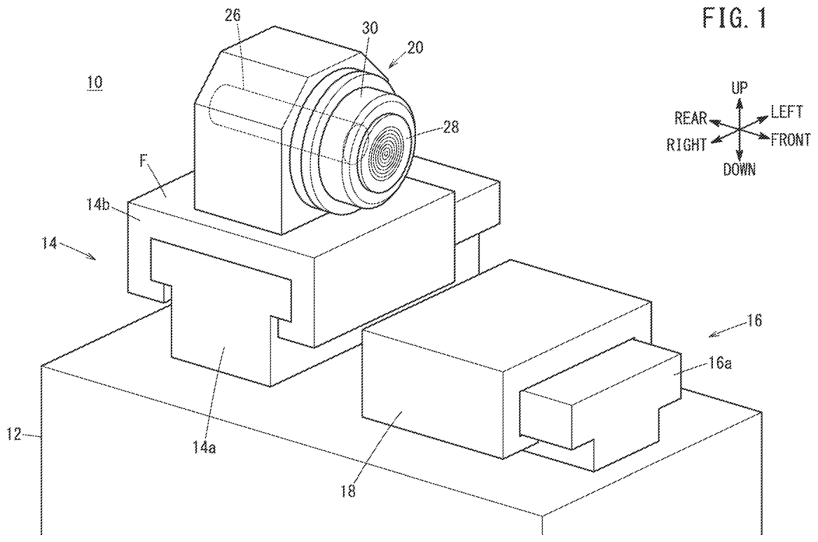

A balance correction assistance device, a machine tool, and a balance correction assistance method according to an embodiment will be described with reference to FIGS. 1 to 6. FIG. 1 is a schematic view of the machine tool according to the present embodiment.

A machine tool (precision machine tool) 10 according to the present embodiment machines a workpiece (an object to be machined) (not shown) with a tool (not shown). As shown in FIG. 1, the machine tool 10 includes a base bed 12, a spindle support 14, a table support 16, a table 18, and a spindle device 20.

The spindle device 20 is provided with a static pressure bearing (not shown) capable of controlling machining on a workpiece with a nanometer-level accuracy, but is not limited thereto. In the present embodiment, a case where the machine tool 10 is a lathe machine will be described as an example, but the present invention should not be limited to this. The present invention can be applied to various machine tools 10 other than a lathe machine, such as a processing machine, a cutting machine and the like.

The spindle device 20 is provided with a spindle 26. A longitudinal direction (axial direction) of the spindle 26 is defined as a front-rear direction. A direction orthogonal to the axial direction in a plane parallel to a mounting surface F on which the spindle device 20 is mounted, is defined as a left-right direction. A direction orthogonal to the mounting surface F on which the spindle device 20 is mounted and to the axial direction is defined as an up-down direction. The downward direction is the direction in which gravity acts. A side on which a rotating body 28 to be described later is positioned, with respect to the spindle 26 is referred to as a front side. A side opposite to the side where the rotating body 28 is positioned, with respect to the spindle 26 is referred to as a rear side. The left-right direction of the spindle device 20 is shown in FIG. 1. In a state in which the operator views the spindle device 20 from the front side of the spindle 26, the right side for the operator is the left side for the spindle device 20, and the left side for the operator is the right side for the spindle device 20.

The spindle support 14 is provided on the base bed 12. The spindle device 20 is located on the spindle support 14.

The spindle support 14 includes a first base portion 14a, a spindle moving table 14b, and an unillustrated first drive mechanism. The first base portion 14a is mounted on the base bed 12. The longitudinal direction of the first base portion 14a is the left-right direction. The first drive mechanism includes an unillustrated motor. The first drive mechanism further includes a ball screw (not shown) rotated by a motor and a nut (not shown) screwed onto the ball screw and connected to the spindle moving table 14b. The first drive mechanism moves the spindle moving table 14b along the longitudinal direction of the first base portion 14a. As the first drive mechanism moves the spindle moving table 14b in the longitudinal direction of the first base portion 14a, the spindle device 20 provided on the spindle moving table 14b moves in the left-right direction.

The table support 16 is provided on the base bed 12. The table support 16 includes a second base portion 16a and an unillustrated second drive mechanism. The longitudinal direction of the second base portion 16a is the front-rear direction. The second drive mechanism includes an unillustrated motor. The second drive mechanism further includes a ball screw (not shown) rotated by a motor and a nut (not shown) screwed onto the ball screw and connected to the table 18. The second drive mechanism moves the table 18 along the longitudinal direction of the second base portion 16a. That is, the second drive mechanism moves the table 18 in the front-rear direction. In addition, the table 18 may be configured to be rotatable about an axis extending along the up-down direction, serving as a rotary axis thereof.

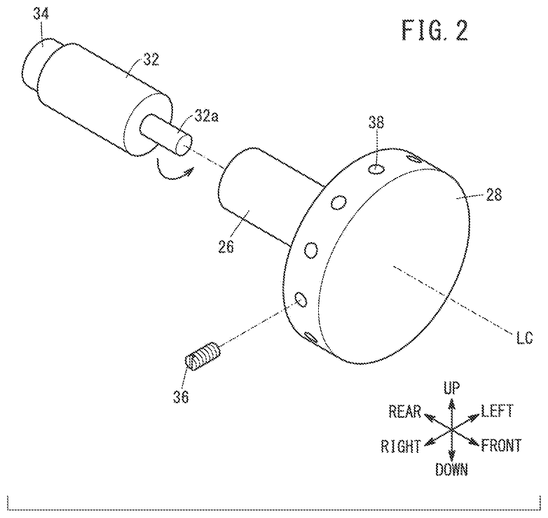

FIG. 2 is a perspective view showing a part of the machine tool according to the present embodiment.

The rotating body 28 is provided at one end of the spindle 26 (the front side of the spindle 26). In a case where the machine tool 10 is a lathe machine, the rotating body 28 is, for example, a face plate or a chuck. The shape of the rotating body 28 is, for example, circular (disc-shaped). The rotating body 28 can rotate integrally with the spindle 26 about the rotation center line LC.

A motor (spindle motor) 32 is provided at the other end of the spindle 26 (the rear side of the spindle 26). As the motor 32, for example, a spindle motor may be used, but the motor 32 is not limited thereto. The motor 32 includes a rotation shaft 32a connected to the spindle 26. The motor 32 can rotate the rotation shaft 32a to thereby rotate the spindle 26 and the rotating body 28.

The rotating body 28 attracts and holds, for example, a workpiece under suction. The table 18 can hold, for example, a tool. Note that a tool may be held by the rotating body 28 while a workpiece may be held on the table 18.

The spindle device 20 may further include a cover member 30 (see FIG. 1) that covers a side portion of the rotating body 28.

The motor 32 is provided with a rotational position detector 34. For example, an encoder or the like may be used as the rotational position detector 34. As the encoder, for example, a rotary encoder can be used, but the encoder is not limited thereto. The rotational position detector 34 can detect the rotation angle of the motor 32. That is, the rotational position detector 34 can detect the rotational position of the rotating body 28.

The rotating body 28 includes, formed therein, a plurality of weight attaching/detaching portions 38 which a weight 36 for balance adjustment can be attached to and detached from. The weight 36 for balance adjustment (balance adjustment weight) can be constituted by, for example, a set screw or the like, but is not limited thereto. In the case where the balance adjustment weight 36 is constituted by a set screw or the like, the weight attaching/detaching portions 38 may be constituted by screw holes into which the set screw can be screw-engaged.

The depth direction of each of the weight attaching/detaching portions 38 is, for example, a radial direction of the rotating body 28. The plurality of weight attaching/detaching portions 38 are formed so as to extend radially around the rotation center line LC. Each weight attaching/detaching portion 38 is opened on a side surface of the rotating body 28. The plurality of weight attaching/detaching portions 38 are arranged at equal intervals in the circumferential direction of the rotating body 28. Here, a case where the depth direction of the weight attaching/detaching portions 38 is the radial direction of the rotating body 28 will be described as an example, but the present invention is not limited thereto. The depth direction of the weight attaching/detaching portions 38 may be parallel to the rotation center line LC.

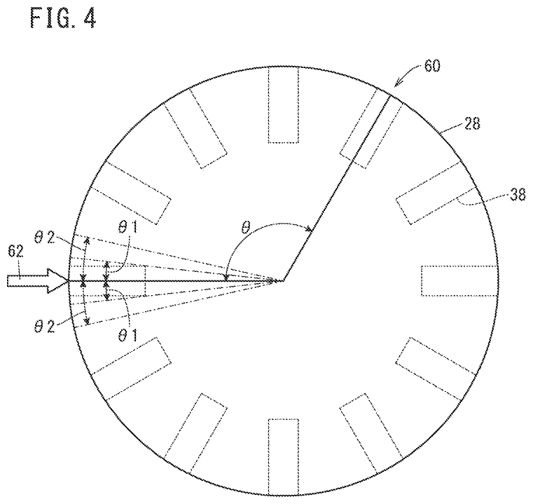

When the balance adjustment weight 36 is attached to or detached from the weight attaching/detaching portion 38, the position of the center of gravity of the rotating body 28 is changed. Therefore, the balance state of the rotating body 28 can be corrected by attaching/detaching the balance adjustment weight 36 to/from the weight attaching/detaching portion 38. Attaching and detaching of the balance adjustment weight 36 can be performed by, for example, a person, more specifically, an operator, but is not limited thereto. Attaching and detaching of the balance adjustment weight 36 may be performed by a robot. Attaching and detaching of the balance adjustment weight 36 can be performed at a predetermined operation position 62 (see FIG. 4) as described later.

The set screw constituting the weight 36 for balance adjustment can be fixed at a desired position (a desired depth). When the set screw constituting the weight 36 for balance adjustment is turned, the position of the weight 36 in the radial direction of the rotating body 28 is changed. That is, when the set screw constituting the balance adjustment weight 36 is turned, the distance from the rotation center line LC to the weight 36 changes. When the position of the weight 36 relative to the rotation center line LC changes, the centrifugal force applied to the weight 36 when the rotating body 28 rotates changes. When the centrifugal force applied to the weight 36 changes when the rotating body 28 rotates, the overall balance of the centrifugal force applied to the rotating body 28 changes. Therefore, the balance state of the rotating body 28 can be finely adjusted by changing the position of the weight 36 in the radial direction of the rotating body 28. The adjustment of the depth at which the set screw constituting the balance adjustment weight 36 is fixed can be performed by a person (operator), but is not limited thereto. The adjustment of the depth at which the set screw constituting the balance adjustment weight 36 is fixed may be performed by a robot.

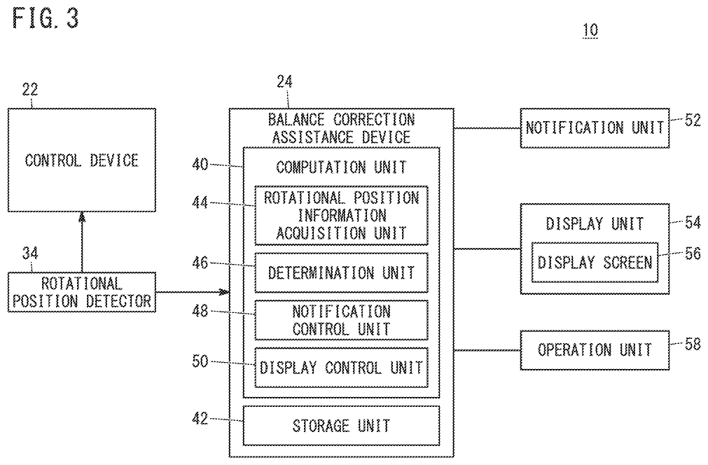

FIG. 3 is a block diagram showing part of the machine tool according to the present embodiment.

As shown in FIG. 3, the machine tool 10 is further provided with a control device 22 and a balance correction assistance device 24.

The control device 22 governs overall control of the machine tool 10.

The balance correction assistance device 24 assists the correction of the balance state when the balance state of the rotating body 28 is corrected. Although the balance correction assistance device 24 is provided separately from the control device 22 in the example shown in FIG. 3, the balance correction assistance device 24 may be incorporated in the control device 22.

As described above, the rotational position detector 34 can detect the rotation angle of the motor 32. That is, the rotational position detector 34 can detect the rotational position of the rotating body 28. Information indicating the rotational position detected by the rotational position detector 34 can be supplied to each of the control device 22 and the balance correction assistance device 24. The information indicating the rotational position of the rotating body 28 may be supplied from the rotational position detector 34 to the balance correction assistance device 24 via the control device 22.

The balance correction assistance device 24 is equipped with a computation unit 40 and a storage unit 42. The computation unit 40 may be configured by a processor such as a CPU (Central Processing Unit) or the like, however the present invention is not limited to this feature. The storage unit 42 is equipped with a volatile memory and a nonvolatile memory, neither of which are shown. As examples of the volatile memory, there may be cited a RAM (Random Access Memory) or the like. As examples of the nonvolatile memory, there may be cited a ROM (Read Only Memory), a flash memory, or the like. Programs, data, tables, and the like can be stored in the storage unit 42.

The computation unit 40 includes a rotational position information acquisition unit 44, a determination unit 46, a notification control unit 48, and a display control unit 50. The rotational position information acquisition unit 44, the determination unit 46, the notification control unit 48, and the display control unit 50 can be realized by the computation unit 40 executing a program stored in the storage unit 42.

The machine tool 10 further includes a notification unit 52. The notification unit 52 performs notification by sound. The notification unit 52 can be constituted, for example, by a speaker or the like, however the present invention is not limited to this feature. For example, the notification unit 52 may be configured by a buzzer.

The machine tool 10 is further provided with a display unit (display) 54. The display unit 54 can be constituted, for example, by a liquid crystal display or the like, however the present invention is not limited to this feature. The display unit 54 includes a display screen 56. The position at which the display unit 54 is disposed is not particularly limited, but the display unit 54 is generally disposed at a position different from a position on the base bed 12. In a state where an operator views the rotating body 28 from the front side of the rotating body 28, the line of sight of the operator often does not coincide with the display screen 56 of the display unit 54.

The machine tool 10 further includes an operation unit 58. The operation unit 58 can be constituted, for example, by a touch panel, a keyboard, a mouse, or the like, none of which are shown. The touch panel may be provided on the display screen 56 of the display unit 54. The user can give an instruction or the like to the balance correction assistance device 24 by operating the operation unit 58.

FIG. 4 is a schematic view showing the rotating body. FIG. 4 shows the rotating body 28 viewed from the front side.

The weight 36 for balance adjustment (see FIG. 2) can be attached to and detached from the weight attaching/detaching portion 38 corresponding to an attachment/detachment position 60 among the plurality of weight attaching/detaching portions 38 provided in the rotating body 28. The attachment/detachment position 60 is a position on the rotating body 28 designated as a position at which the balance adjustment weight 36 should be attached to and detached from the rotating body 28. The attachment/detachment position 60 can be determined based on an observation result obtained by using, for example, a field balancer or the like. The field balancer is a device capable of observing a balance state of rotation of a rotationally-driven observation target. The attachment/detachment position 60 is determined based on the observation result obtained by using the field balancer or the like, and information indicating the determined attachment/detachment position 60 is supplied to the balance correction assistance device 24. Such information can be input by the operator operating the operation unit 58, for example. The information indicating the attachment/detachment position 60 may be stored in the storage unit 42. Here, a case where the information indicating the attachment/detachment position 60 is input by the operator will be described as an example, but the present invention is not limited thereto. The information indicating the attachment/detachment position 60 may be automatically supplied from the field balancer, the control device 22, or the like to the balance correction assistance device 24.

Attaching and detaching of the balance adjustment weight 36 can be performed at a predetermined operation position 62. The operation position 62 is a position where a person or a robot performs attaching and detaching of the balance adjustment weight 36 to or from the rotating body 28. For attaching or detaching the balance adjustment weight 36, the rotating body 28 is rotated by an operator or the like such that the attachment/detachment position 60 coincides with the operation position 62. For rotating the rotating body 28 such that the attachment/detachment position 60 coincides with the operation position 62, the rotating body 28 may be rotated by a hand or the like of the operator, or the rotating body 28 may be rotated based on an instruction input by the operator via the operation unit 58. The balance adjustment weight 36 can be attached and detached in a state where the attachment/detachment position 60 and the operation position 62 coincide with each other. In the example shown in FIG. 4, the operation position 62 is set, for example, at a position on the left side of the rotating body 28 as viewed from the front side. The operation position 62 is not limited to such a position on the left side of the rotating body 28. For example, the operation position 62 may be set at a position on the right side of the rotating body 28. Further, the operation position 62 may be set at a position on the upper side of the rotating body 28. That is, the operation position 62 may be set to a desired position. The information indicating the operation position 62 may be stored in advance in the storage unit 42.

The rotational position information acquisition unit 44 acquires information indicating the rotational position of the rotating body 28 from the rotational position detector 34. The rotational position information acquisition unit 44 determines the current rotational position of the rotating body 28 based on the information acquired from the rotational position detector 34, and supplies information indicating the current rotational position of the rotating body 28 to the determination unit 46. Here, a case where the current rotational position of the rotating body 28 is determined by the rotational position information acquisition unit 44 will be described as an example, but the present invention is not limited thereto. The current rotational position of the rotating body 28 may be determined by the determination unit 46 based on the information supplied from the rotational position information acquisition unit 44.

As described above, when the balance adjustment weight 36 is attached or detached, the rotating body 28 may be rotated by the operator or the like such that the attachment/detachment position 60 coincides with the operation position 62. The determination unit 46 can determine the rotation angle difference θ in the circumferential direction of the rotating body 28 between the operation position 62 and the current attachment/detachment position 60 based on the information indicating the current rotational position of the rotating body 28. The determination unit 46 supplies information indicating the rotation angle difference θ to the notification control unit 48.

The notification control unit 48 can determine whether or not the absolute value of the rotation angle difference θ in the circumferential direction of the rotating body 28 between the operation position 62 and the current attachment/detachment position 60 is less than a threshold value θ1. If the absolute value of the rotation angle difference θ is less than the threshold value θ1, the notification unit 52 is caused to notify by sound that the absolute value of the rotation angle difference θ is less than the threshold value θ1. Since it is notified that the absolute value of the rotation angle difference θ is less than the threshold value θ1, the operator can grasp that the rotation angle difference θ has become sufficiently small.

The notification control unit 48 can determine whether or not the absolute value of the rotation angle difference θ is greater than or equal to the threshold value θ1 and less than a threshold value θ2 that is greater than the threshold value θ1. If the absolute value of the rotation angle difference θ is greater than or equal to the threshold value θ1 and less than the threshold value θ2, the notification control unit 48 can cause the notification unit 52 to notify that the absolute value of the rotation angle difference θ is greater than or equal to the threshold value θ1 and less than the threshold value θ2. Since it is notified that the absolute value of the rotation angle difference θ is greater than or equal to the threshold value θ1 and less than the threshold value θ2, the operator can grasp that the rotation angle difference θ is reduced to some extent but is not sufficiently reduced.

In the above description, the case where the notification control unit 48 determines whether or not the absolute value of the rotation angle difference θ is less than the threshold value θ1 has been described as an example, but the present invention is not limited thereto. The determination unit 46 may determine whether or not the absolute value of the rotation angle difference θ is less than the threshold value θ1. In this case, information indicating whether or not the absolute value of the rotation angle difference θ is less than the threshold value θ1 may be supplied from the determination unit 46 to the notification control unit 48.

In the above description, the case where the notification control unit 48 determines whether or not the absolute value of the rotation angle difference θ is greater than or equal to the threshold value θ1 and less than the threshold value θ2 has been described as an example, but the present invention is not limited thereto. The determination unit 46 may determine whether the absolute value of the rotation angle difference θ is greater than or equal to the threshold value θ1 and less than the threshold value θ2. In this case, information indicating whether or not the absolute value of the rotation angle difference θ is greater than or equal to the threshold value θ1 and less than the threshold value θ2 may be supplied from the determination unit 46 to the notification control unit 48.

If the absolute value of the rotation angle difference θ is less than the threshold value θ1, the notification control unit 48 causes the notification unit 52 to generate a sound of a first mode. The sound of the first mode is, for example, a continuous sound.

If the absolute value of the rotation angle difference θ is greater than or equal to the threshold value θ1 and less than the threshold value θ2, the notification control unit 48 causes the notification unit 52 to generate a sound of a second mode different from the first mode. The sound of the second mode is, for example, an intermittent sound.

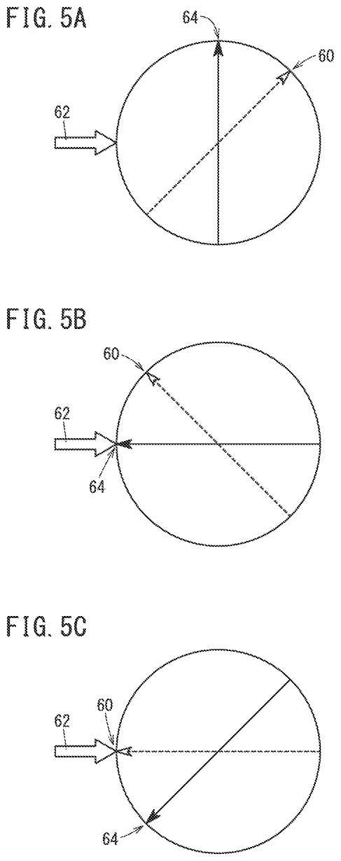

FIGS. 5A, 5B, and 5C are diagrams illustrating examples of the display screen.

The display control unit 50 can display the relationship between the operation position 62 and the current attachment/detachment position 60 on the display screen 56 of the display unit 54. More specifically, the display control unit 50 can cause the display screen 56 of the display unit 54 to display the relationship between the operation position 62, the current attachment/detachment position 60, and the current origin position 64 of the rotating body 28.

The solid-line arrow in FIGS. 5A to 5C indicates the origin position 64 of the rotating body 28. The broken-line arrow in FIGS. 5A to 5C indicates the attachment/detachment position 60.

An example in which the origin position 64 of the rotating body 28 is located on the upper side is shown in FIG. 5A. An example in which the origin position 64 of the rotating body 28 coincides with the operation position 62 is shown in FIG. 5B. An example in which the attachment/detachment position 60 coincides with the operation position 62 is shown in FIG. 5C.

In this way, the relationship between the attachment/detachment position 60 and the operation position 62 can be displayed on the display screen 56 of the display unit 54. The operator can grasp the relationship between the attachment/detachment position 60 and the operation position 62 by looking at the display screen 56 of the display unit 54. However, when attaching/detaching the weight 36 for balance adjustment, the operator often looks at the rotating body 28 from the front side of the rotating body 28. As described above, in a state where the operator is looking at the rotating body 28 from the front side of the rotating body 28, the line of sight of the operator generally does not coincide with the display screen 56. In the present embodiment, as described above, if the absolute value of the rotation angle difference θ between the attachment/detachment position 60 and the operation position 62 becomes greater than or equal to the threshold value θ1 and less than the threshold value θ2, the notification unit 52 notifies by sound that the absolute value of the rotation angle difference θ has become greater than or equal to the threshold value θ1 and less than the threshold value θ2. Therefore, the operator can recognize by sound that the rotation angle difference θ is reduced to some extent but is not sufficiently reduced, without looking at the display screen 56 of the display unit 54. In addition, in the present embodiment, if the absolute value of the rotation angle difference θ becomes less than the threshold value θ1, the notification unit 52 notifies by sound that the absolute value of the rotation angle difference θ has become less than the threshold value θ1. Therefore, the operator can recognize by sound that the rotation angle difference θ has become sufficiently small, without looking at the display screen 56 of the display unit 54. As described above, according to the present embodiment, the operator can grasp the rotation angle difference θ by sound without looking at the display screen 56 of the display unit 54. Therefore, according to the present embodiment, it is possible to contribute to facilitation of balance correction.

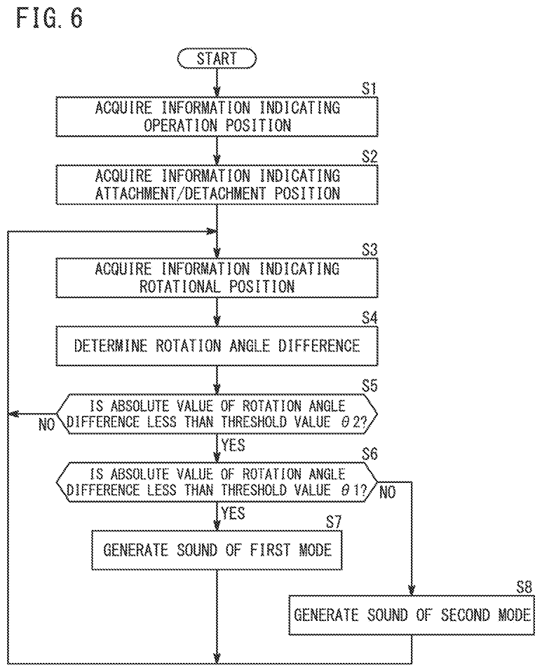

FIG. 6 is a flowchart showing the operation of the balance correction assistance device according to the present embodiment. When the operation illustrated in FIG. 6 is performed, information indicating the attachment/detachment position 60 is input in advance. Information indicating the operation position 62 is determined in advance.

In step S1, the determination unit 46 acquires information indicating the operation position 62. Specifically, the determination unit 46 reads the information indicating the operation position 62 stored in the storage unit 42. Thereafter, the process transitions to step S2.

In step S2, the determination unit 46 acquires information indicating the attachment/detachment position 60. Specifically, the determination unit 46 reads the information indicating the attachment/detachment position 60 stored in the storage unit 42. Thereafter, the process transitions to step S3.

In step S3, the rotational position information acquisition unit 44 acquires information indicating the current rotational position of the rotating body 28 from the rotational position detector 34, and supplies the acquired information to the determination unit 46. Thereafter, the process transitions to step S4.

In step S4, the determination unit 46 determines the rotation angle difference θ in the circumferential direction of the rotating body 28 between the operation position 62 and the current attachment/detachment position 60, based on the information indicating the current rotational position of the rotating body 28, the information indicating the attachment/detachment position 60, and the information indicating the operation position 62. After this, the process moves to step S5.

In step S5, the notification control unit 48 determines whether or not the absolute value of the rotation angle difference θ in the circumferential direction of the rotating body 28 between the operation position 62 and the current attachment/detachment position 60 is less than the threshold value θ2. If the absolute value of the rotation angle difference θ is less than the threshold value θ2 (YES in step S5), the process proceeds to step S6. When the absolute value of the rotation angle difference θ is greater than or equal to the threshold value θ2 (NO in step S5), the step S3 and the subsequent steps are repeated.

In step S6, the notification control unit 48 determines whether or not the absolute value of the rotation angle difference θ in the circumferential direction of the rotating body 28 between the operation position 62 and the current attachment/detachment position 60 is less than the threshold value θ1. If the absolute value of the rotation angle difference θ is less than the threshold value θ1 (YES in step S6), the process proceeds to step S7. If the absolute value of the rotation angle difference θ is greater than or equal to the threshold value θ1 (NO in step S6), the process proceeds to step S8.

In step S7, the notification control unit 48 causes the notification unit 52 to generate the sound of the first mode. Thereafter, the step S3 and the subsequent steps are repeated.

In step S8, the notification control unit 48 causes the notification unit 52 to generate the sound of the second mode. Thereafter, the step S3 and the subsequent steps are repeated. In this way, the process shown in FIG. 6 is executed.

As described above, according to the present embodiment, when the absolute value of the rotation angle difference θ in the circumferential direction of the rotating body 28 between the operation position 62 and the current attachment/detachment position 60 is less than the threshold value θ1, the notification unit 52 notifies by sound that the absolute value of the rotation angle difference θ is less than the threshold value θ1. Therefore, according to the present embodiment, the operator can grasp the rotation angle difference θ by sound without looking at the display screen 56 or the like of the display unit 54. Therefore, according to the present embodiment, it is possible to contribute to facilitation of balance correction.

### Modified Examples

Although a preferred embodiment of the present invention have been described above, the present invention is not limited to the above-described embodiment, and various modifications can be made thereto within a range that does not depart from the essence and gist of the present invention.

For example, the above embodiment has described the case where the longitudinal direction of the spindle 26 intersects the vertical direction as an example, but the present invention should not be limited to this. The longitudinal direction of the spindle 26 may extend in the vertical direction.

In addition, the above embodiment has described, as an example, the case in which, when the absolute value of the rotation angle difference θ is greater than or equal to the threshold value θ1 and less than the threshold value θ2, the notification unit 52 notifies by sound that the absolute value of the rotation angle difference θ is greater than or equal to the threshold value θ1 and less than the threshold value θ2. However, the present invention is not limited thereto. When the absolute value of the rotation angle difference θ is greater than or equal to the threshold value θ1 and less than the threshold value θ2, the notification unit 52 does not have to necessarily notify that the absolute value of the rotation angle difference θ is greater than or equal to the threshold value θ1 and less than the threshold value θ2. That is, only the fact that the absolute value of the rotation angle difference θ is less than the threshold value θ1 may be notified by sound from the notification unit 52.

In the above-described embodiment, the case where the sound of the first mode is a continuous sound and the sound of the second mode is an intermittent sound has been described as an example, but the present invention is not limited thereto. For example, the sound of the first mode may be a sound having a first sound volume, and the sound of the second mode may be a sound having a second sound volume that is lower than the first sound volume. That is, the rotation angle difference θ may be expressed by the loudness of sound. The sound of the first mode may be a sound having a first pitch, and the sound of the second mode may be a sound having a second pitch lower than the first pitch. That is, the rotation angle difference θ may be expressed by a pitch.

In the embodiment described above, the sound of the first mode is generated when the absolute value of the rotation angle difference θ is less than the threshold value θ1, and the sound of the second mode is generated when the absolute value of the rotation angle difference θ is greater than or equal to the threshold value θ1 and less than the threshold value θ2. That is, in the above-described embodiment, states of the rotation angle difference are distinguished by two types of sounds. However, the invention should not be limited to this. The states thereof may be distinguished by three or more types of sounds. For example, when the absolute value of the rotation angle difference θ is less than the threshold value θ1, the sound of the first mode may be generated as in the above-described embodiment. When the absolute value of the rotation angle difference θ is greater than or equal to the threshold value θ1 and less than the threshold value θ2, the sound of the second mode may be generated as in the above-described embodiment. When the absolute value of the rotation angle difference θ is greater than or equal to the threshold value θ2 and less than a threshold value θ3 greater than the threshold value θ2, a sound of a third mode different from the sound of the first mode and different from the sound of the second mode may be generated.

The above-described embodiments may be summarized in the following manner.

The balance correction assistance device (24) for assisting correction of the balance state of the rotating body (28) having a circular shape, includes: the storage unit (42) configured to store the attachment/detachment position (60) that is a position on the rotating body and that is designated as a position at which the balance adjustment weight (36) should be attached to and detached from the rotating body, and the operation position (62) predetermined as a position at which a person or a robot performs attaching and detaching of the balance adjustment weight to and from the rotating body; the rotational position information acquisition unit (44) configured to acquire information indicating the rotational position of the rotating body from the rotational position detector (34); the determination unit (46) configured to determine the rotation angle difference (θ) in the circumferential direction of the rotating body between the operation position and the current attachment/detachment position based on the rotational position; and the notification control unit (48) configured to, when the absolute value of the rotation angle difference is less than the first threshold value, cause the notification unit (52) to notify by sound that the absolute value of the rotation angle difference is less than the first threshold value (θ1). According to such a configuration, the operator can grasp the rotation angle difference by sound without looking at the display screen or the like of the display unit. Therefore, according to such a configuration, it is possible to contribute to facilitation of balance correction.

When the absolute value of the rotation angle difference is greater than or equal to the first threshold value and less than the second threshold value (θ2) greater than the first threshold value, the notification control unit may cause the notification unit to notify that the absolute value of the rotation angle difference is greater than or equal to the first threshold value and less than the second threshold value. According to such a configuration, the operator can recognize by sound that the absolute value of the rotation angle difference is equal to or greater than the first threshold value and less than the second threshold value, without looking at the display screen or the like of the display unit. That is, according to such a configuration, the operator can grasp that the rotation angle difference is reduced to some extent but is not sufficiently reduced, by sound without looking at the display screen or the like of the display unit.

When the absolute value of the rotation angle difference is less than the first threshold value, the notification control unit may cause the notification unit to generate the sound of the first mode, and when the absolute value of the rotation angle difference is greater than or equal to the first threshold value and less than the second threshold value, the notification control unit may cause the notification unit to generate the sound of the second mode that is different from the first mode.

The sound of the first mode may be a continuous sound, and the sound of the second mode may be an intermittent sound.

The sound of the first mode may be a sound having a first sound volume, and the sound of the second mode may be a sound having a second sound volume lower than the first sound volume.

The sound of the first mode may be a sound having a first pitch, and the sound of the second mode may be a sound having a second pitch lower than the first pitch.

The balance correction assistance device may further include the display control unit (50) configured to cause the display unit (54) to display the relationship between the operation position and the current attachment/detachment position. According to such a configuration, the operator can grasp the relationship between the operation position and the current attachment/detachment position regardless of whether or not the sound is emitted from the notification unit.

The display control unit may cause the display unit to display the relationship between the operation position, the current attachment/detachment position, and the current origin position (64) of the rotating body.

The rotating body may be provided on the spindle (26) with which the machine tool (10) is equipped, and may rotate integrally with the spindle.

The machine tool (10) is equipped with the balance correction assistance device as described above.

The balance correction assistance method for assisting correction of the balance state of the rotating body having a circular shape, includes: an attachment/detachment position information acquisition step (S2) of acquiring information indicating the attachment/detachment position that is a position on the rotating body and that is designated as a position at which the balance adjustment weight should be attached to and detached from the rotating body; a rotational position information acquisition step (S3) of acquiring information indicating the rotational position of the rotating body; a determination step (S4) of determining, based on the rotational position, the rotation angle difference in the circumferential direction of the rotating body between the operation position predetermined as a position at which a person or a robot performs attaching and detaching of the balance adjustment weight to and from the rotating body and the current attachment/detachment position; and a notification step (S6, S7) of, when the absolute value of the rotation angle difference is less than the first threshold value, notifying by sound that the absolute value of the rotation angle difference is less than the first threshold value.

In the notification step, when the absolute value of the rotation angle difference is greater than or equal to the first threshold value and less than the second threshold value greater than the first threshold value, notification that the absolute value of the rotation angle difference is greater than or equal to the first threshold value and less than the second threshold value may be given by using sound (S5, S6, S8).

In the notification step, notification may be given by using the sound of the first mode (S7) when the absolute value of the rotation angle difference is less than the first threshold value, and notification may be given by using the sound of the second mode different from the first mode (S8) when the absolute value of the rotation angle difference is greater than or equal to the first threshold value and less than the second threshold value.

The sound of the first mode may be a continuous sound, and the sound of the second mode may be an intermittent sound.

The sound of the first mode may be a sound having a first sound volume, and the sound of the second mode may be a sound having a second sound volume lower than the first sound volume.

1. A balance correction assistance device for assisting correction of a balance state of a rotating body having a circular shape, the balance correction assistance device comprising:
a storage unit configured to store an attachment/detachment position that is a position on the rotating body and that is designated as a position at which a balance adjustment weight should be attached to and detached from the rotating body, and an operation position predetermined as a position at which a person or a robot performs attaching and detaching of the balance adjustment weight to and from the rotating body;
a rotational position information acquisition unit configured to acquire information indicating a rotational position of the rotating body from a rotational position detector;
a determination unit configured to determine a rotation angle difference in a circumferential direction of the rotating body between the operation position and the attachment/detachment position at present, based on the rotational position; and
a notification control unit configured to, when an absolute value of the rotation angle difference is less than a first threshold value, cause a notification unit to notify by sound that the absolute value of the rotation angle difference is less than the first threshold value.

2. The balance correction assistance device according to claim 1, wherein
when the absolute value of the rotation angle difference is greater than or equal to the first threshold value and less than a second threshold value greater than the first threshold value, the notification control unit causes the notification unit to notify that the absolute value of the rotation angle difference is greater than or equal to the first threshold value and less than the second threshold value.

3. The balance correction assistance device according to claim 2, wherein
when the absolute value of the rotation angle difference is less than the first threshold value, the notification control unit causes the notification unit to generate a sound of a first mode, and when the absolute value of the rotation angle difference is greater than or equal to the first threshold value and less than the second threshold value, the notification control unit causes the notification unit to generate a sound of a second mode that is different from the first mode.

4. The balance correction assistance device according to claim 3, wherein
the sound of the first mode is a continuous sound, and
the sound of the second mode is an intermittent sound.

5. The balance correction assistance device according to claim 3, wherein
the sound of the first mode is a sound having a first sound volume, and
the sound of the second mode is a sound having a second sound volume lower than the first sound volume.

6. The balance correction assistance device according to claim 3, wherein
the sound of the first mode is a sound having a first pitch, and
the sound of the second mode is a sound having a second pitch that is lower than the first pitch.

7. The balance correction assistance device according to claim 1, further comprising:
a display control unit configured to cause a display unit to display a relationship between the operation position and the current attachment/detachment position.

8. The balance correction assistance device according to claim 7, wherein
the display control unit causes the display unit to display a relationship between the operation position, the current attachment/detachment position, and a current origin position of the rotating body.

9. The balance correction assistance device according to claim 1, wherein
the rotating body is provided on a spindle with which a machine tool is equipped, and the rotating body rotates integrally with the spindle.

10. A machine tool comprising the balance correction assistance device according to claim 1.

11. A balance correction assistance method for assisting correction of a balance state of a rotating body having a circular shape, the balance correction assistance method comprising:
an attachment/detachment position information acquisition step of acquiring information indicating an attachment/detachment position that is a position on the rotating body and that is designated as a position at which a balance adjustment weight should be attached to and detached from the rotating body;
a rotational position information acquisition step of acquiring information indicating a rotational position of the rotating body;
a determination step of determining, based on the rotational position, a rotation angle difference in a circumferential direction of the rotating body between an operation position predetermined as a position at which a person or a robot performs attaching and detaching of the balance adjustment weight to and from the rotating body and the attachment/detachment position at present; and
a notification step of, when an absolute value of the rotation angle difference is less than a first threshold value, notifying by sound that the absolute value of the rotation angle difference is less than the first threshold value.

12. The balance correction assistance method according to claim 11, wherein
the notification step comprises, when the absolute value of the rotation angle difference is greater than or equal to the first threshold value and less than a second threshold value greater than the first threshold value, notifying by sound that the absolute value of the rotation angle difference is greater than or equal to the first threshold value and less than the second threshold value.

13. The balance correction assistance method according to claim 12, wherein
the notification step further comprises: giving notification by using a sound of a first mode when the absolute value of the rotation angle difference is less than the first threshold value; and giving notification by using a sound of a second mode different from the first mode when the absolute value of the rotation angle difference is greater than or equal to the first threshold value and less than the second threshold value.

14. The balance correction assistance method according to claim 13, wherein
the sound of the first mode is a continuous sound, and
the sound of the second mode is an intermittent sound.

15. The balance correction assistance method according to claim 13, wherein
the sound of the first mode is a sound having a first sound volume, and
the sound of the second mode is a sound having a second sound volume lower than the first sound volume.
